(19) United States
(12) Patent Application Publication
(10) Pub. No.: US 2007/0086546 A1
(43) Pub. Date: Apr. 19, 2007

(54) Baseband receiver using transition trigger and method thereof

(75) Inventors: Ji-hun Koo, Yongin-si (KR); Seon-wook Kim, Namyangju-si (KR); Seok-joong Hwang, Paju-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/543,128

(22) Filed: Oct. 5, 2006

(30) Foreign Application Priority Data
Oct. 13, 2005 (KR) 10-2005-0096743

(51) Int. Cl. H04L 27/06

(52) U.S. Cl. 375/340; 340/10.1

(57) ABSTRACT

A baseband receiver using a transition trigger and a method thereof are disclosed. The baseband receiver is provided in a radio frequency identification (RFID) reader in order to receive a pulse amplitude modulation (PAM) signal, and can improve a bit error rate (BER) performance by mapping transition waveforms generated whenever the received signal is triggered on new symbols, and filtering the new symbols to recover to the original symbols. Since no complex and high performance DC drift estimator is required and DC drifts can stably be removed along with white noise among noise components, it is possible to improve BER.

This application claims priority from Korean Patent Application No. 10-2005-0096743 filed on Oct. 13, 2005 in the Korean Intellectual Property Office, the disclosure of which is incorporated herein by reference.

### BACKGROUND OF THE INVENTION

1. Field of the Invention

Apparatuses and methods consistent with the present invention generally relate to a baseband receiver using a transition trigger, and more particularly, to a baseband receiver provided in a radio frequency identification (RFID) reader for receiving a pulse amplitude modulation (PAM) signal, for improving a bit error rate (BER) performance by mapping transition waveforms generated whenever the received signal is triggered, on new symbols and filtering the new symbols to recover the original symbols.

2. Description of the Related Art

FIG. 1A is a schematic block diagram illustrating the internal construction of a related art RFID reader.

The related art RFID reader includes a modulator 110, a low pass filter (LPF) 120, a baseband transmitter 130, a local oscillator 140, a demodulator 150, an LPF 160, and a baseband receiver 170.

The related art RFID reader transmits signals over an antenna ANT after passing through the baseband transmitter 130, the LPF 120 and the modulator 110, and demodulates the received signals received over the antenna ANT by way of the demodulator 150, the LPF 160, and the baseband receiver 170.

However, when the RFID reader uses a direct conversion mode, great DC drifts occur therein. Also, when the RFID reader demodulates the received signals, transmission leakage having high signal intensity continuously occurs. The transmission leakage is greater than that of the received signals by 30 dB or greater. Since the RFID reader receives reception data in a short time period after transmitting transmission data, DC drifts occur. For example, when a backscattering link frequency is in the range of 40 KHz based on EPCglobal Class1 Gen2, the interval between the transmission time and the reception time is 250 μs.

Therefore, since various standards and various link frequencies exist in the case of the RFID reader that receives digital PAM signals, a baseband receiver that can process such various standards and various link frequencies is required.

Meanwhile, FIG. 1B is a schematic block diagram illustrating the construction of a related art digital PAM receiver.

The related art digital PAM receiver includes a synthesizer 180, a matched filter 182, a switch 184, and a threshold comparator 186.

The synthesizer 180 outputs a synthesizing signal r(t) obtained by synthesizing additive white Gaussian noise (AWGN) and a source signal. The matched filter 182 makes a signal to noise ratio (SNR) of output signals at a time period of a symbol (t=T). At this time, the maximum SNR of the matched filter 182 can be expressed as Equation 1.

$${SNR}_{MAX} = \frac{2 E}{{N}_{0}} \qquad [ Equation 1 ]$$

In Equation 1, E represents energy of an input signal S, and N₀/2 represents power spectrum density of input noise.

The impulse response of the matched filter 182 is expressed as Equation 2.
h(t)=ks(T−t) [Equation 2]

In Equation 2, t is greater than or equal to 0 and smaller than or equal to T, and S(t)=S₁(t)−S₂(t). S₁(t) represents a reference signal 1, S₂(t) represents a reference signal 2, and k is an arbitrary constant.

Supposing that only AWGN exists in the aforementioned matched filter 182, a digital PAM receiver available for all the line-coding modes uses a matched filter having impulse response expressed as Equation 3.
h(t)=u(t)−u(t−T), H(f)=Tsinc(fT)e^{-jπfT} [Equation 3]

Furthermore, when DC drifts exist, SNR spectrum density of the matched filter 182 is expressed as Equation 4.

$$[ Equation 4 ] \\ {( \frac{S}{N} )}_{T} = \frac{{\vert {\int }_{- ∞}^{∞} H ( f ) S ( f ) {ⅇ}^{j2π fT} ⅆ f \vert}^{2}}{{N}_{0} / 2 {\int }_{∞}^{- ∞} \vert H ( f ) \vert ⅆ f + {\vert {\int }_{∞}^{- ∞} H ( f ) {N}_{Drift} ( f ) {ⅇ}^{j2π fT} ⅆ f \vert}^{2}} \qquad ( 4 )$$

In Equation 4, S(f) represents a source signal, N₀/2 represents spectrum density of AWGN, and N_{Drift}(f) represents DC drift components.

Supposing that H(f)e^{j2πfT}=Ĥ^{(f)}, it is noted that the maximum SNR is obtained in case where

$${\vert {\int }_{- ∞}^{∞} \hat{H} ( f ) {N}_{Drift} ( f ) ⅆ f \vert}^{2}$$

has a minimum value.

However, since Ĥ^{(f)} spectrum in SNR of the matched filter 182 has no attenuation to DC, it fails to suppress DC noise corresponding to DC drift. This is because the existing universal digital PAM receiver filters DC components ranging 0<t<T through the matched filter 182. Under such circumstances, a problem occurs in that the maximum SNR is not obtained.

Therefore, to solve such a problem, the existing digital PAM receiver uses a filter provided at the front of the matched filter 182 to remove DC drifts. This filter is required to remove only DC drifts without damaging symbols. Also, the existing digital PAM receiver has problems in that its transmission signal is much greater than the received signal similarly to the RFID reader, and needs to stably remove DC drifts within a limited time period until a response after transmission if the transmission signal is detected in the receiver.

Further, the existing digital PAM receiver estimates DC drifts to correct a threshold value through the threshold comparator 186. However, to this end, an additional DC drift estimator is required. Since frequency components of symbols are not spaced apart from frequency components of DC drifts within a great range, a complex and high performance DC drift estimator that can identify the frequency components is required.

Further, the existing digital PAM receiver needs line-coding for symbols to obtain Ĥ^{(f)}·N_{drift}(f)=0. However, if the existing digital PAM receiver has various line-coding standards and variable link frequencies like the RFID reader, it is difficult to obtain H(t) that can satisfy all the coding standards and the link frequencies.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

An aspect of the present invention provides a baseband receiver using a transition trigger and a method thereof. The baseband receiver is provided in a radio frequency identification (RFID) reader for receiving a pulse amplitude modulation (PAM) signal, and can improve a bit error rate (BER) performance by mapping transition waveforms generated whenever the received signal is triggered, on new symbols and filtering the new symbols to recover the original symbols.

In order to achieve the above-described aspects of the present invention, there is provided a baseband receiver of an RFID reader, which comprises a transition filter which filters a trigger waveform appearing from a rising edge to a falling edge or appearing from a falling edge to a rising edge of an input first symbol, and outputs a second symbol; a threshold comparator comparing existence/nonexistence of transitions in the second symbol input from the transition filter based on a threshold value, and outputs a transition symbol; and a transition converter which recovers the first symbol based on the existence/nonexistence of transitions in the transition symbol.

In another aspect of the present invention, there is provided a baseband receiving method for an RFID reader that generates a first symbol by synthesizing a received signal and an AWGN signal, the method comprising a) generating a second symbol based on a transition trigger of the first symbol, b) comparing the second symbol with a threshold value and generating a transition symbol, and c) converting the transition symbol and recovering the first symbol.

The transition trigger or the transition means a conversion from a rising edge to a falling edge or from a falling edge to a rising edge.

The first symbol may include states of rising trigger and maintenance, and states of falling trigger and maintenance.

The second symbol represents a rising point of a high level if the first symbol is a rising trigger, and the second symbol represents a falling point of a low level if the first symbol is a falling trigger.

The second symbol represents a zero state having no transition if the first symbol is maintained at a high level having no transition, and the second symbol represents a zero state having no transition if the first symbol is maintained at a low level having no transition.

The second symbol has an impulse response h(t) expressed as h(t)=u(t)−2u(t−T)+u(t−2T), wherein t is greater than or equal to 0 and is smaller than or equal to 2T.

The second symbol has a frequency response H(f) expressed as H(f)=Tsinc(fT)(e^{-jπfT}−e^{-3jπfT}).

The second symbol is classified into a transition region and a non-transition region based on the threshold value.

The transition symbol represents a high level to correspond to the second symbol if the second symbol has transitions, and represents a low level if the second symbol has no transition.

The converting includes repeating a rising trigger or a falling trigger if the transition symbol is in a high level state, and maintaining a high level or a low level to recover the first symbol if the transition symbol is in a low level state.

### BRIEF DESCRIPTION OF THE DRAWINGS

The above aspects and features of the present invention will be more apparent by describing certain exemplary embodiments of the present invention with reference to the accompanying drawings, in which:

FIG. 1A is a schematic block diagram illustrating the internal construction of a related art RFID reader;

FIG. 1B is a schematic block diagram illustrating the construction of a related art digital PAM receiver;

FIG. 2 is a schematic block diagram illustrating a baseband receiver using a transition trigger according to a exemplary embodiment of the present invention;

FIG. 3 is a view illustrating waveforms of a first symbol, a second symbol and a transition symbol;

FIG. 4 is a view illustrating a transition state used by a transition converter; and

FIG. 5 is a view illustrating output waveforms of a first symbol, a second symbol, a transition symbol, and a transition converter.

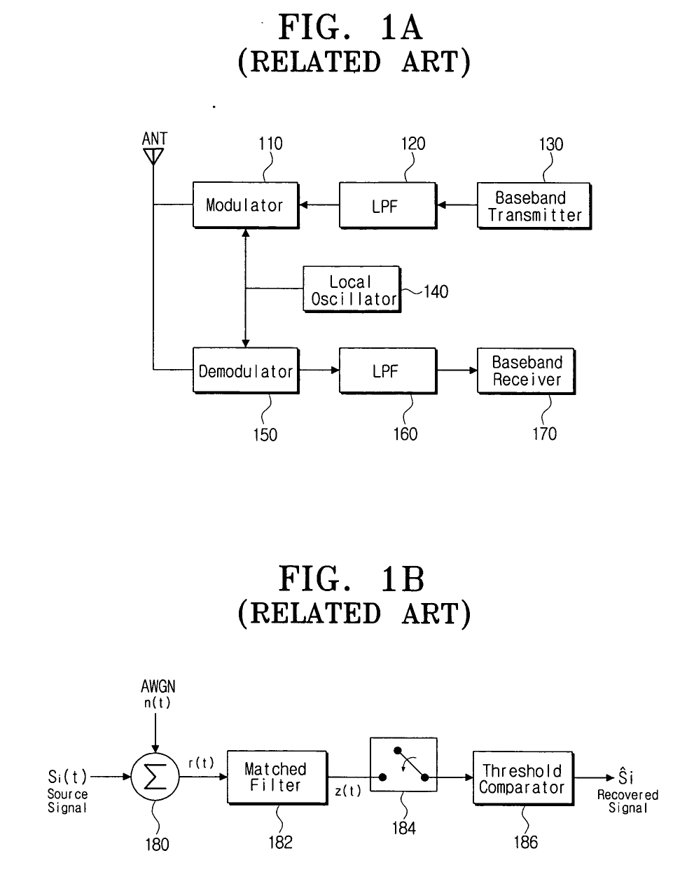

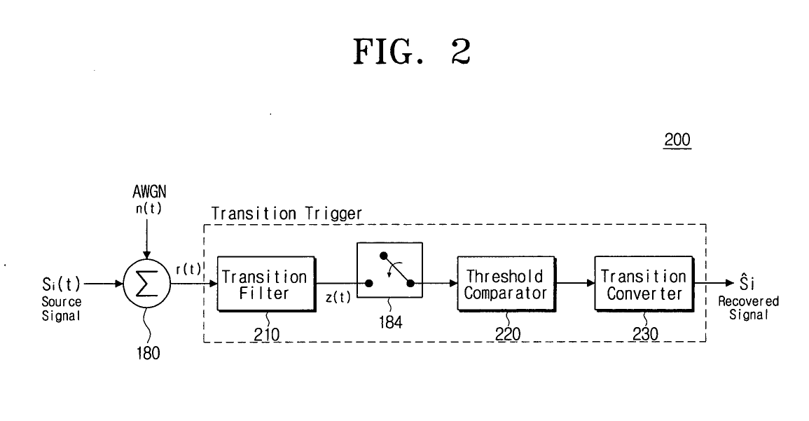

### DETAILED DESCRIPTION OF EXEMPLARY EMBODIMENTS

Certain exemplary embodiments of the present invention will be described in greater detail with reference to the accompanying drawings. In the whole description of the present invention, the same drawing reference numerals are used for the same elements across various figures. The related art elements or their detailed description will be omitted if it is determined that they impede the subject matter of the present invention.

In the exemplary embodiment of the present invention, a transition trigger is used when frequency components of source signals are not spaced apart from frequency components of DC drifts within a great range and when various link frequencies of the source signals and various line-coding modes need to be satisfied.

FIG. 2 is a schematic block diagram illustrating a baseband receiver using a transition trigger according to an exemplary embodiment of the present invention.

The baseband receiver 200 includes a transition filter 210, a switch 184, a threshold comparator 220, and a transition converter 230.

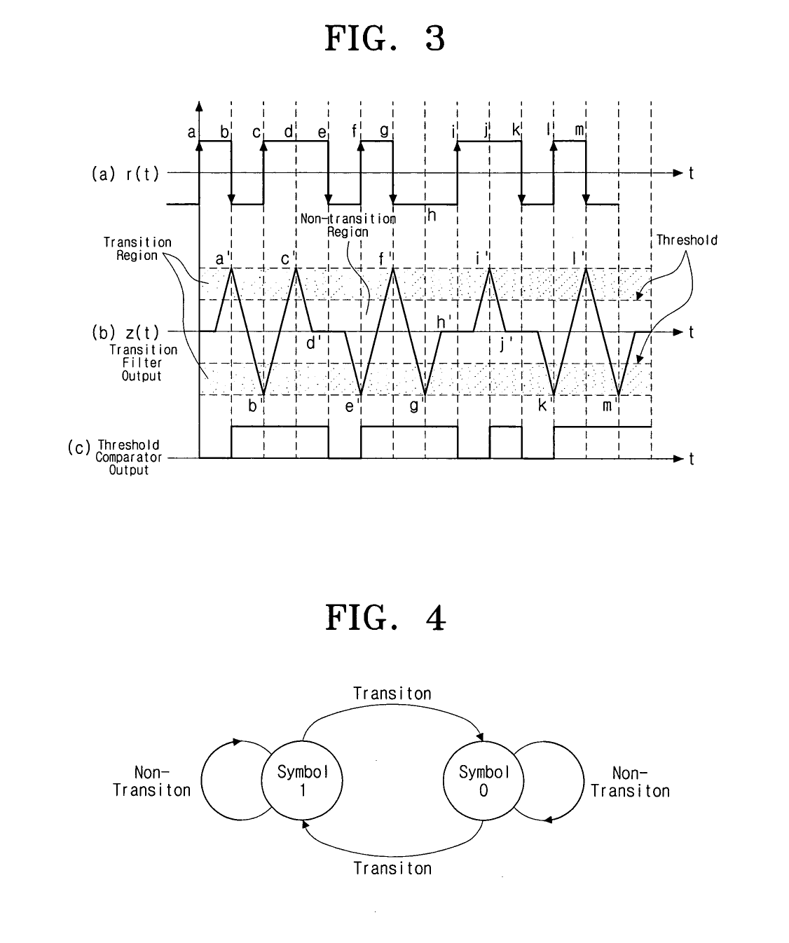

The transition filter 210 maps transition waveforms between signal levels with new symbols and carries out filtering in reference to the symbols. In detail, the transition filter 210 filters trigger waveforms during falling edge from rising edge or rising edge from falling edge, as shown in (a) of FIG. 3, with respect to a first symbol input from a synthesizer 180, and outputs a second symbol as shown in (b) of FIG. 3. Therefore, the output waveform shown in (b) of FIG. 3 is mapped with new symbols. In this case, mapping allows the output waveform shown in (b) of FIG. 3, i.e., new symbols, to correspond to the original symbols shown in (a) of FIG. 3 so as to obtain the output waveform shown in (c) of FIG. 3.

The switch 184 switches to connect the transition filter 210 with the threshold comparator 220 to deliver the second symbol output from the transition filter 210 to the threshold comparator 220.

The threshold comparator 220 compares the presence or absence of transition for the second symbol input from the transition filter 210 based on a threshold value and outputs a transition symbol. In other words, the threshold comparator 220 compares whether transition points a′-j′ belong to a transition region or a non-transition region in the output waveform shown in (b) of FIG. 3. For example, if the transition points a′-j′ belong to the transition region, the threshold comparator 220 recognizes that transition occurs in a corresponding transition point. Therefore, the waveform of the transition symbol shown in (c) of FIG. 3 is output from the threshold comparator 220.

The transition converter 230 recovers waveforms corresponding to the original symbols shown in (c) of FIG. 3 in accordance with the transition state of this aspect of the present invention based on whether transition occurs in a corresponding transition point after the transition filter 210 maps the transition waveforms between symbols with new symbols.

FIG. 3 is a view illustrating waveforms of the first symbol, the second symbol and the transition symbol.

Referring to FIG. 3, (a) represents a waveform of the first symbol r(t) generated by synthesizing white noise signal n(t) to the received signal Si(t) in a receiver such as an RFID reader that includes a baseband receiver. As shown in (a) of FIG. 3, the waveform of the first symbol r(t) has a rising trigger at a point “a”, a falling trigger at a point “b”, a rising trigger at a point “c”, a high value (no trigger) at a point “d”, a falling trigger at a point “e”, a rising trigger at a point “f”, a falling trigger at a point “g”, a low value (no trigger) at a point “h”, a rising trigger at a point “i”, a high value at a point “j”, a falling trigger at a point “k”, a rising trigger at a point “l”, and a falling trigger at a point “m”.

The first symbol r(t) having the above waveform is input to the transition filter 210. The transition filter 210 filters the first symbol r(t) to output waveform of the second symbol z(t) as shown in (b) of FIG. 3. At this time, an impulse response h(t) of the transition filter 210 is expressed as Equation 5, and a frequency response H(f) of the transition filter 210 is expressed as Equation 6.
h(t)=u(t)−2u(t−T)+u(t−2T) [Equation 5]

In Equation 5, t is greater than or equal to 0 and is smaller than or equal to 2T.
H(f)=Tsinc(fT)(e^{-jπfT}−e^{-3jπfT}) [Equation 6]

Meanwhile, (b) of FIG. 3 represents a waveform of the second symbol z(t). The second symbol z(t) output from the transition filter 210 generates the output waveform shown in (b) of FIG. 3 whenever the transition trigger is generated.

More specifically, in the waveform shown in (b) of FIG. 3, the second symbol represents a rising point of a high level at a point “a′” if the first symbol is a rising trigger at a point “a”. The second symbol represents a falling point of a low level at a point “b′” if the first symbol is a falling trigger at a point “b”.

Likewise, the second symbol represents a rising point of a high level at a point “c′” if the first symbol is a rising trigger at a point “c”. The second symbol represents a zero state at a point “d′” if the first symbol is maintained at a high level having no transition at a point “d”.

The second symbol represents a falling point of a low level at a point “e′” if the first symbol is a falling trigger at a point “e”. The second symbol represents a rising point of a high level at a point “f” if the first symbol is a rising trigger at a point “f”.

The second symbol represents a falling point of a low level at a point “g′” if the first symbol is a falling trigger at a point “g”. The second symbol represents a zero state at a point “h′” if the first symbol is maintained at a low level having no transition at a point “h”.

The second symbol represents a rising point of a high level at a point “i′” if the first symbol is a rising trigger at a point “i”. The second symbol represents a zero state at a point “j′” if the first symbol is maintained at a high level having no transition at a point “j”.

The second symbol represents a falling point of a low level at a point “k′” if the first symbol is a falling trigger at a point “k”. The second symbol represents a rising point of a high level at a point “l′” if the first symbol is a rising trigger at a point “l”.

Finally, the second symbol represents a falling point of a low level at a point “m′” if the first symbol is a falling trigger at a point “m”. Therefore, the output of the transition filter 210 is classified into two regions, i.e., a transition region that detects the rising edge or falling edge and a non-transition region having no transition.

In FIG. 3, (c) represents a waveform of the transition symbol generated depending on transition after the second symbol z(t) is compared with the threshold value through the threshold comparator 220.

If a transition greater than the threshold value exists in the waveform of the second symbol z(t) shown in (b) of FIG. 3, for example, if transition such as trigger of +1 or −1 exists, the transition symbol is in a high level state. If no transition exists in the waveform of the second symbol z(t), the transition symbol is in a low level state. In this case, the low level of the transition symbol means a zero level.

As shown in (c) of FIG. 3, the output signal of the transition filter 210, i.e., since the transition symbol corresponds to transition of +1 if the second symbol corresponds to a point “a′”, the transition symbol is in a high level state. Also, since the transition symbol corresponds to transition of −1 if the second symbol corresponds to a point “b′”, the transition symbol is in a high level state.

Since the transition symbol corresponds to transition of +1 if the second symbol corresponds to a point “c′”, the transition symbol is in a high level state. And, since the transition symbol corresponds to no transition if the second symbol corresponds to a point “d′”, the transition symbol is in a low level state.

Since the transition symbol corresponds to transition of −1 if the second symbol corresponds to a point “e′”, the transition symbol is in a low level state. And, since the transition symbol corresponds to transition of +1 if the second symbol corresponds to a point “f”, the transition symbol is in a high level state.

Since the transition symbol corresponds to transition of −1 if the second symbol corresponds to a point “g′”, the transition symbol is in a high level state. And, since the transition symbol corresponds to no transition if the second symbol corresponds to a point “h′”, the transition symbol is in a low level state.

Since the transition symbol corresponds to transition of +1 if the second symbol corresponds to a point “i′”, the transition symbol is in a high level state. And, since the transition symbol corresponds to no transition if the second symbol corresponds to a point “j′”, the transition symbol is in a low level state.

Since the transition symbol corresponds to transition of −1 if the second symbol corresponds to a point “k′”, the transition symbol is in a high level state. And, since the transition symbol corresponds to transition of +1 if the second symbol corresponds to a point “1′”, the transition symbol is in a high level state. Also, since the transition symbol corresponds to transition of −1 if the second symbol corresponds to a point “m′”, the transition symbol is in a low level state.

FIG. 4 is a view illustrating the transition state used in the transition converter.

The transition converter 230 recovers the transition symbol shown in (c) of FIG. 3 to the original first symbol based on the transition state diagram of FIG. 4.

In the transition state diagram shown in FIG. 4, if the symbol 1 of a high level is converted into the symbol 0 of a low level, transition occurs. Also, even if the symbol 0 of a low level is converted to the symbol 1 of a high level, it is regarded that transition occurs.

Meanwhile, no transition occurs if the symbol 1 of a high level is maintained as it is. Also, no transition occurs if the symbol 0 of a low level is maintained as it is.

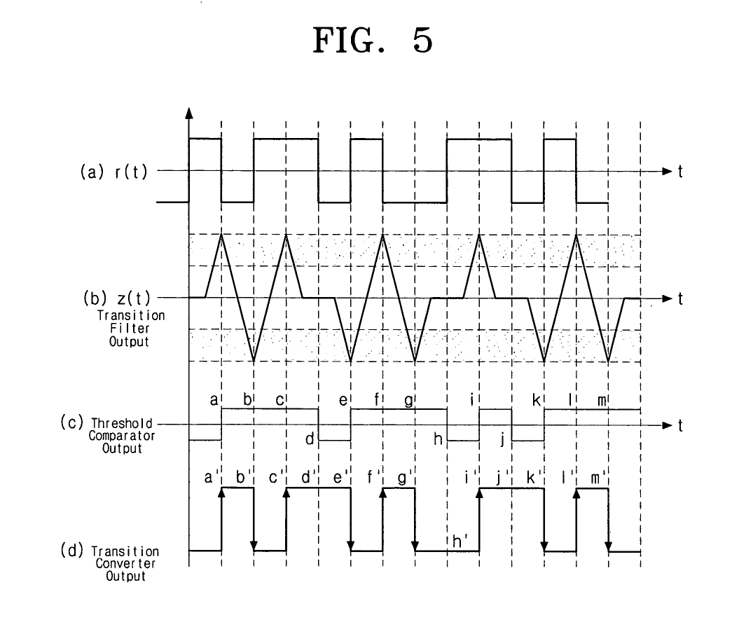

Therefore, the transition converter 230 recovers the transition symbol shown in (c) of FIG. 5 to the original first symbol shown in (d) of FIG. 5 in accordance with the transition state.

FIG. 5 is a view illustrating output waveforms of the first symbol, the second symbol, the transition symbol, and the transition converter.

Referring to FIG. 5, (a) represents the original first symbol input to the transition filter 210, and (b) represents the second symbol output from the transition filter 210. Since the first and second symbols have been described as above, their description will be omitted.

(c) of FIG. 5 represents the transition symbol output from the threshold comparator 220. Since the transition symbol has been also described as above, its description will be omitted.

(d) of FIG. 5 represents the original first symbol recovered from the transition symbol by the transition converter 230 in accordance with the transition state.

As shown in (d) of FIG. 5, since the transition symbol is maintained at a high level having transition at a point “a”, the output signal of the transition converter 230, i.e., the first symbol represents a rising trigger like a point “a′”. And, since the transition symbol is maintained at a high level having transition at a point “b”, the first symbol represents a falling trigger like a point “b′”

Since the transition symbol is maintained at a high level having transition at a point “c”, the first symbol represents a rising trigger like a point “c′”. And, since the transition symbol is maintained at a low level having no transition at a point “d”, the first symbol is maintained at a high level corresponding to a prior level.

Since the transition symbol is maintained at a high level having transition at a point “e”, the first symbol represents a falling trigger like a point “e′”. And, since the transition symbol is maintained at a high level having transition at a point “f”, the first symbol represents a rising trigger like “f′”.

Since the transition symbol is maintained at a high level having transition at a point “g”, the first symbol represents a falling trigger like a point “g′”. And, since the transition symbol is maintained at a low level having no transition at a point “h”, the first symbol is maintained at a low level like “h′”.

Since the transition symbol is maintained at a high level having transition at a point “i”, the first symbol represents a rising trigger like a point “i′”. And, since the transition symbol is maintained at a low level having no transition at a point “j”, the first symbol is maintained at prior high level like “j′”.

Since the transition symbol is maintained at a high level having transition at a point “k”, the first symbol represents a falling trigger like a point “k′”. And, since the transition symbol is maintained at a high level having transition at a point “1”, the first symbol represents a rising trigger like “l′”.

Also, since the transition symbol is maintained at a high level having transition at a point “m”, the first symbol represents a falling trigger.

Therefore, the original first symbol can be recovered by the aforementioned procedure.

As described above, in the present invention, complex and high performance DC drift estimator is not required. Also, since DC drifts can stably be removed along with white noise among noise components, it is possible to improve BER.

The foregoing exemplary embodiments are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A baseband receiver of a radio frequency identification (RFID) reader, the receiver comprising:
a transition filter which filters a trigger waveform appearing from a rising edge to a falling edge or appearing from a falling edge to a rising edge of an input first symbol, and outputs a second symbol;
a threshold comparator which compares whether transitions exist in the second symbol input from the transition filter based on a threshold value, and outputs a transition symbol; and
a transition converter which recovers the first symbol based on the existence or nonexistence of transitions in the transition symbol.

2. The baseband receiver as claimed in claim 1, wherein the first symbol comprises states of rising trigger and maintenance, and states of falling trigger and maintenance.

3. The baseband receiver as claimed in claim 1, wherein the transition represents a trigger of the first symbol converted from the rising edge to the falling edge or from the falling edge to the rising edge.

4. The baseband receiver as claimed in claim 1, wherein the second symbol represents a rising point of a high level if the first symbol is a rising trigger, and the second symbol represents a falling point of a low level if the first symbol is a falling trigger.

5. The baseband receiver as claimed in claim 1, wherein the second symbol represents a zero state having no transition if the first symbol is maintained at a high level having no transition, and the second symbol represents a zero state having no transition if the first symbol is maintained at a low level having no transition.

6. The baseband receiver as claimed in claim 1, wherein the second symbol is classified into a transition region and a non-transition region based on the threshold value.

7. The baseband receiver as claimed in claim 1, wherein the transition symbol represents a high level to correspond to the second symbol if the second symbol has transitions, and represents a low level if the second symbol has no transition.

8. The baseband receiver as claimed in claim 1, wherein the transition converter repeats a rising trigger or a falling trigger if the transition symbol is in a high level state, and maintains a high level or a low level to recover the first symbol if the transition symbol is in a low level state.

9. The baseband receiver as claimed in claim 1, wherein the second symbol has an impulse response h(t) expressed as h(t)=u(t)−2u(t−T)+u(t−2T), wherein t is greater than or equal to 0 and is smaller than or equal to 2T.

10. The baseband receiver as claimed in claim 1, wherein the second symbol has a frequency response H(f) expressed as H(f)=Tsinc(fT)(e^{-jπfT}−e^{-3jπfT}).

11. A baseband receiving method for a radio frequency identification (RFID) reader that generates a first symbol by synthesizing a received signal and an additive white Gaussian noise (AWGN) signal, the method comprising:
generating a second symbol based on a transition trigger of the first symbol;
comparing the second symbol with a threshold value and generating a transition symbol; and
converting the transition symbol and recovering the first symbol.

12. The method as claimed in claim 11, wherein the transition trigger is converted from a rising edge to a falling edge, or from a falling edge to a rising edge.

13. The method as claimed in claim 11, wherein the first symbol comprises states of rising trigger and maintenance, and states of falling trigger and maintenance.

14. The method as claimed in claim 11, wherein the second symbol represents a rising point of a high level if the first symbol is a rising trigger, and the second symbol represents a falling point of a low level if the first symbol is a falling trigger.

15. The method as claimed in claim 11, wherein the second symbol represents a zero state having no transition if the first symbol is maintained at a high level having no transition, and the second symbol represents a zero state having no transition if the first symbol is maintained at a low level having no transition.

16. The method as claimed in claim 11, wherein the second symbol has an impulse response h(t) expressed as h(t)=u(t)−2u(t−T)+u(t−2T), wherein t is greater than or equal to 0 and is smaller than or equal to 2T.

17. The method as claimed in claim 11, wherein the second symbol has a frequency response H(f) expressed as H(f)=Tsinc(fT)(e^{-jπfT}−e^{-3jπfT}).

18. The method as claimed in claim 11, wherein the second symbol is classified into a transition region and a non-transition region based on the threshold value.

19. The method as claimed in claim 11, wherein the transition symbol represents a high level to correspond to the second symbol if the second symbol has transitions, and represents a low level if the second symbol has no transition.

20. The method as claimed in claim 11, wherein the converting comprises repeating a rising trigger or a falling trigger if the transition symbol is in a high level state, and maintaining a high level or a low level to recover the first symbol if the transition symbol is in a low level state.
